(19) United States
(12) Patent Application Publication
(10) Pub. No.: US 2007/0209180 A1
(43) Pub. Date: Sep. 13, 2007

(54) Carpet Seaming Tool

(76) Inventor: Donald W. Hoffrogge, Dillsboro, IN (US)

Correspondence Address: WOOD, HERRON & EVANS, LLP, 2700 CAREW TOWER, 441 VINE STREET, CINCINNATI, OH, 45202, US

(21) Appl. No.: 11/276,648

(22) Filed: Mar. 9, 2006

(51) Int. Cl. B23P 13/00

(52) U.S. Cl. 29/242; 29/270; 29/284

(57) ABSTRACT

A carpet tool for use in laying carpets and treating the seams or edges of laid carpets includes a frame supporting a pair of shafts, a handle extending from the frame and at least one roller supported on one of the shafts and a plurality of toothed wheels supported on the other shaft. In one embodiment, the frame includes a yoke having a bight between separate sets of legs extending from the bight. The handle extends from the bight along an axis disposed at about 45° with respect to the direction of extension of each of the separate sets of legs.

### FIELD OF THE INVENTION

This invention relates to carpet seaming tools and more particularly to carpet seaming tools used in laying carpets and treating the seams or edges of laid carpets.

### BACKGROUND OF THE INVENTION

When laying carpet, it is common to join adjacent edges of two carpet pieces along a seam. Typically, a heat activated adhesive tape is placed along the floor under the edges. The adhesive on the tape is activated by an iron or other heating device and the edges pushed onto the sticky adhesive to form the seam. Fibers of the two carpet pieces are preferably intermingled to hide the seam.

Carpet tools including toothed rollers are used to both press the carpet pieces onto the tape, and to intermingle the fibers.

In the past, carpet seaming tools comprising, for example, a channel-shaped housing with several axles rotatably supporting star-shaped wheels has been used to roll over the seams defined by the adjacent edges of newly laid carpet. The tools both push the carpet edges down onto the underlying adhesive tape or system, and serve to facilitate intermingling of carpet fibers at the seam to obliterate or reduce visibility of the seam and improve the aesthetics of the installation. One such prior tool is shown in U.S. Design Pat. No. D241,704. Others are shown in U.S. Pat. Nos. 4,224,726 and 4,439,904, for example.

Such prior devices tend to utilize star-shaped or toothed roller disks with radially projecting teeth for engaging and intermingling carpet fibers crossing over a seam. And in the past, certain smooth rollers have been proposed for merely pressing the carpet into underlying seams or tape, where cut pile carpets might otherwise snag on star-shaped rollers.

Prior carpet tools are thus inherently disadvantaged. If an operator desires to install one form of carpet, a carpet seam roller with star-shaped wheels or disks is selected. If the carpet is of a cut pile or other type tending to snag on such a tool, then another smooth roller tool must be selected. The installer might thus go to the expense of two tools and to the trouble of having both available.

Accordingly, it has been one objective of the invention to provide a single carpet seaming tool useful for installing all typically desired carpets.

Another objective has been to provide a multi-function carpet tool capable of handling diverse carpet types.

One further difficulty arising from current tools is the actual ease of use. Prior tools may be channel-shaped, or having a handle extending at an angle and welded onto the tool. Such welded construction typically includes a stud welded on the tool for attachment to a handle, and rendering manufacture and tool cost more expensive. Moreover, the handle angle may not be properly set for the most advantageous tool use.

Accordingly, another objective of the invention has been to provide an improved, multiple function carpet seaming tool providing consistent handle angle for all functions of the tool.

Another objective of the invention has been to provide an improved carpet seaming tool with improved handle mounting.

### SUMMARY OF THE INVENTION

Accordingly, in one embodiment of the invention, the invention comprises a multiple-function carpet tool comprising a “Y”-shaped yoke including two legs at each end of the yoke extending from the yoke bight at angles to each other. A shaft runs through each complimentary yoke leg. A smooth roller is mounted on one shaft. A plurality of star-shaped or toothed disks or wheels is mounted on the other shaft. A bolt is disposed through the bight and is secured into a handle perpendicular to the bight. Thus, the yoke legs extend at angles, such as at, but not limited to, 45 degrees from the direction of the handle axis. Other frame structures than yokes can be used to mount the respective shafts, it simply being preferable that 180 degree rotation of the tool abut the handle axis presents one or the other of said shafts parallel to and operably near the carpet to be treated or rolled. With more particularity, each shaft is parallel to the other and each is disposed perpendicularly to a line extending about 45 degrees from an axis on which the tool handle is disposed.

In use, the tool is used in one position to press the star-shaped disks against two carpet edges proximate a seam. For a diverse carpet, the tool is flipped over so the smooth roller can be pressed onto the carpet. For each use, the handle is preferably at the same angle to the carpet, floor or work surface to facilitate ease of consistent use, independent of carpet type.

### BRIEF DESCRIPTION OF THE DRAWINGS

These and other objectives will become readily apparent from the following written description and from the figures in which:

FIG. 1 is a perspective view of a carpet tool according to the invention;

FIG. 2 is a side elevational view of a carpet tool according to the invention;

FIG. 3 is another side elevational view of the tool of FIG. 1 taken at 90 degrees from the view of FIG. 2;

FIG. 4 is a perspective view similar to FIG. 1 of an alternative embodiment of the tool of the invention;

FIG. 5 is a perspective view of a bracket of a single-use alternative embodiment of a tool according to the invention; and

FIGS. 6A and 6B are schematic views illustrating the dual use of the preferred embodiments of the invention.

### DETAILED DESCRIPTION OF THE PREFERRED EMBODIMENT

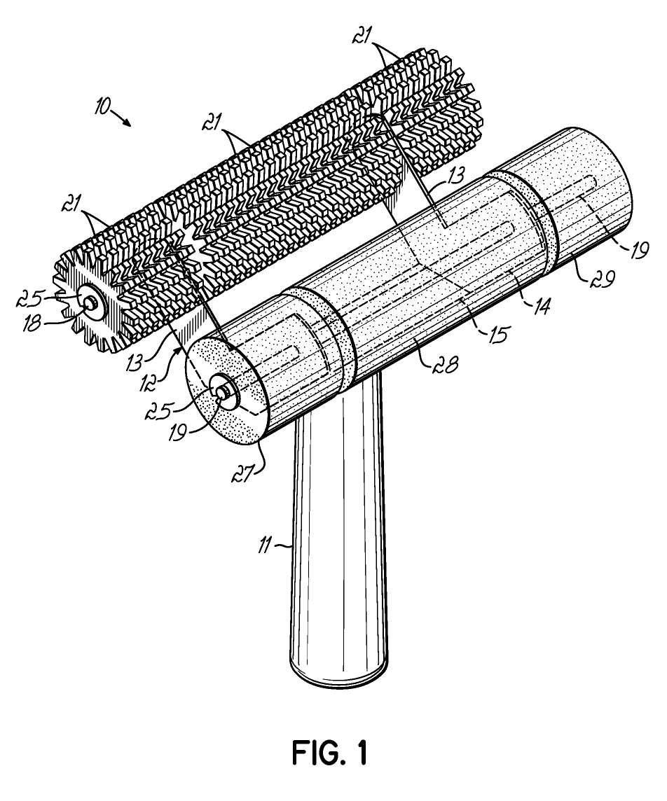

Turning now to FIG. 1, there is shown therein a perspective view of a carpet tool 10 according to the invention. Carpet tool 10 includes a handle 11 and a yoke 12 having two legs 13, 14 extending at right angles to each other and respectively at 45 degrees from a bight member 15. Thus, respective legs 13 on one side and respective legs 14 on the other side each extend from bight 15 at an approximate preferred angle of about 45 degrees with respect to the bight. This extension orients the legs 13, 14 at about 90 degrees extension with respect to each other. Other suitable angles of extension, both of the legs from the bight and of the legs with respect to each other, could be utilized. Thus, the handle and legs 13 or the handle and legs 14 are disposed at an angle preferably less than ninety degrees with respect to each other.

As best shown in FIGS. 1-3, the legs 13 are provided with a shaft 18 and legs 14 are provided with a shaft 19. It will be appreciated that the shafts 18 and 19 extend between respective legs 14, on the one hand, and shaft 18 extends between respective legs 13 on the other.

In other words, it will be appreciated that each leg 13, 14 has a complimentary leg extending at the same angle from the bight 15 and at the other end thereof. Thus, there are two legs 13 parallel to, but spaced from, each other extending from the bight 15 and there are two legs 14 parallel and spaced from each other, extending from the bight 15 with the respective shafts extending between each of the legs similarly disposed.

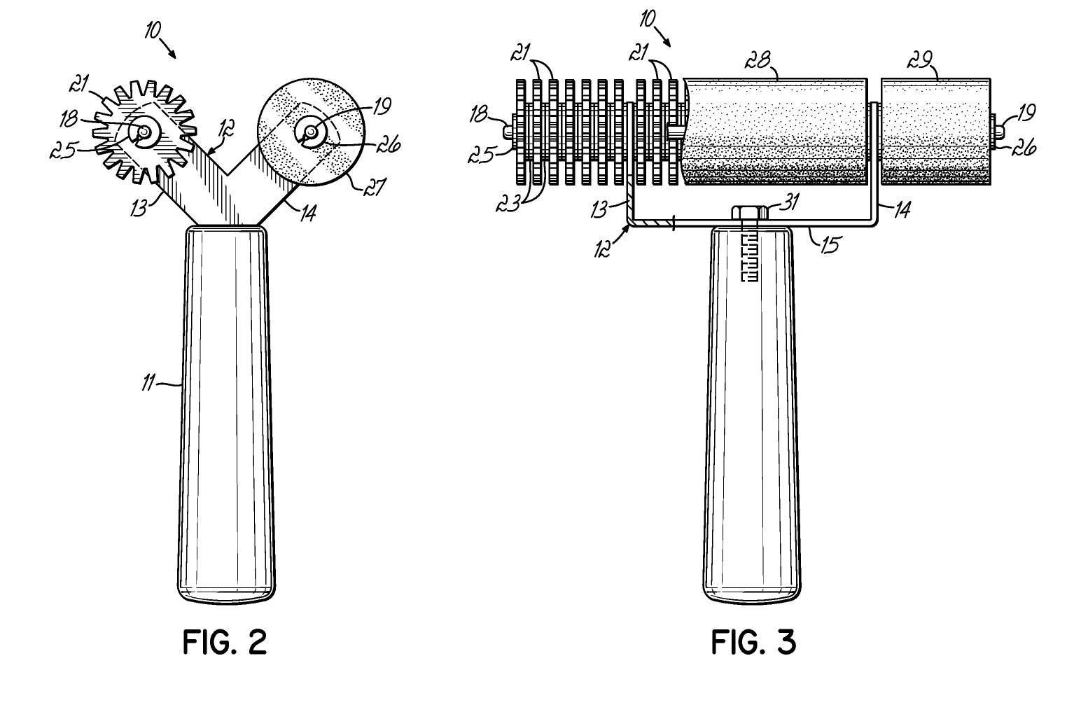

As shown in FIGS. 1 and 2A, shaft 18 carries a plurality of spaced roller wheels or disks 21, each separated by one, two or more washers 23. Disks 21 can be star-shaped or comprises wheels having radially extending, tooth-like projections as shown in FIG. 1. While a variety of forms of toothed wheels or disks 21 can be used in the invention, one preferred form is that wheel available from Curtain-Hebert, Inc. of Gloversville, N.Y. under their Model No. “0 Huntington Cutter Wheel”.

Such wheels are approximately 1¼ inches in diameter. Such toothed disks are preferably stamped and not molded. Molded disks tend to have sharper ends with burrs which may damage the carpet fibers to which they are applied and particularly with respect to certain carpet fibers or weaves. On the other hand, the stamped wheels have smoother surfaces, i.e., without burrs, and do not have a tendency to fray the fiber ends as do molded wheels.

The shaft 18 may be held in the respective arms 13 by means of any shaft end retainer as are well known in the industry.

As shown in FIGS. 1-3, the shaft 18 extends through the arms 13 so that a plurality of the toothed wheels or disks 21 are disposed inside the arms 13 and a plurality of toothed wheels 21 outside the arms 13 between the ends of the shaft 18 at the ends of which are applied keepers, such as keepers 25.

It will be appreciated that this particular embodiment, as also illustrated in FIG. 1, includes a shaft 19 between two cooperating arms 14. On shaft 19 are mounted smooth rollers, such as rollers 27, 28 and 29. Roller 28 is mounted between the arms 14, while end rollers 27 and 29 are respectively mounted outside the arms 14 and between the keepers 26 on the ends of shaft 19. Such rollers can be made from any suitable material and in one embodiment, are made of high density polyethylene rollers having an outside diameter of approximately 1¼ inches.

Shafts 18 and 19 have any suitable diameter, such as ¼ inch.

It will be further appreciated that handle 11 is secured to the yoke 12 by means of a bolt 31, which extends through the bight 15 and outwardly of the tool. The bolt 31 is preferably threaded so that handle 11 can be threaded onto the bolt and secured in place, such as by epoxy, between an internal bore of handle 11 receiving the bolt 13 and the threads of the bolt.

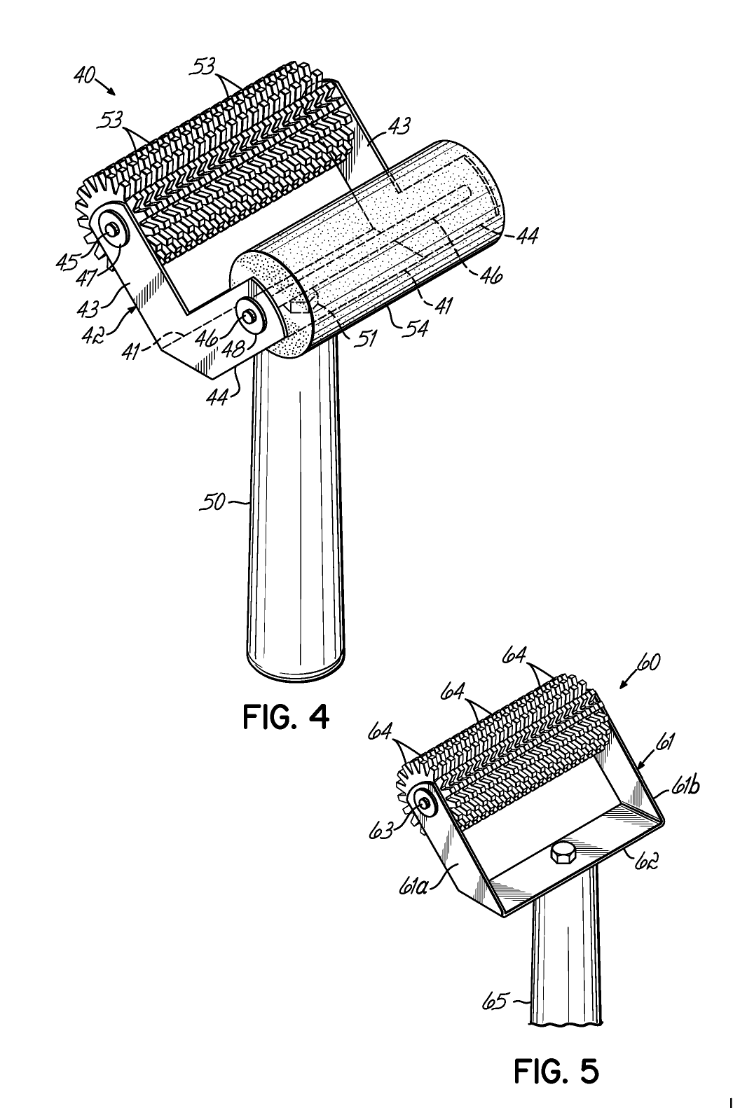

Turning now to FIG. 4, there is illustrated therein an alternative embodiment of the carpet tool as at 40. Carpet tool 40 has the same elevational view as in FIG. 1, however, it will be appreciated that the yoke 42 of the tool 40 also has arms, such as at 43 and at 44, extending in the same direction and orientation as arms 13, 14 of tool 10. In fact, and preferably, the yoke 42 may be identical to the yoke 12 of FIG. 1.

Nevertheless, it will be appreciated that the shafts 45, 46 of the tool 40 are shorter than the respective shafts 18, 19 in FIG. 1, and extend beyond the respective legs 43 and 44, only a distance to accommodate the snap-on retainer, such as the D-rings 47, 48. No disks or rollers are disposed outside arms 43, 44. In addition, it will be appreciated that the handle 50 of the tool 40 is secured by a bolt 51 extending outwardly of the bight 41 and into the handle, where the bolt is threaded into a bore of the handle and can be epoxied or otherwise adhered thereto.

In this way, the extension of the bolt is aligned with the extension of the handle, and the user angle of less than ninety degrees is provided by the bight 41 and the angled legs. It is not necessary to use angled attachment devices for the handle.

Accordingly, with the exception of the length of the respective shafts 45, 46, and the less extensive disposition of disks and rollers, the tool 40 is similar to the tool 10 shown in FIGS. 1-3, the significant difference being that the tool is simply narrower, such as at three inches, rather than the much wider tool, such as the six inch tool provided in FIGS. 1-3. Accordingly, the alternative embodiment provides simply a narrower tool, but having the same other benefits, advantages and uses as the tool 11 previously described.

The toothed wheels 53 and the roller 54 shown in FIG. 4 are the same as those in similar parts 21 and 28 shown in FIGS. 1-3.

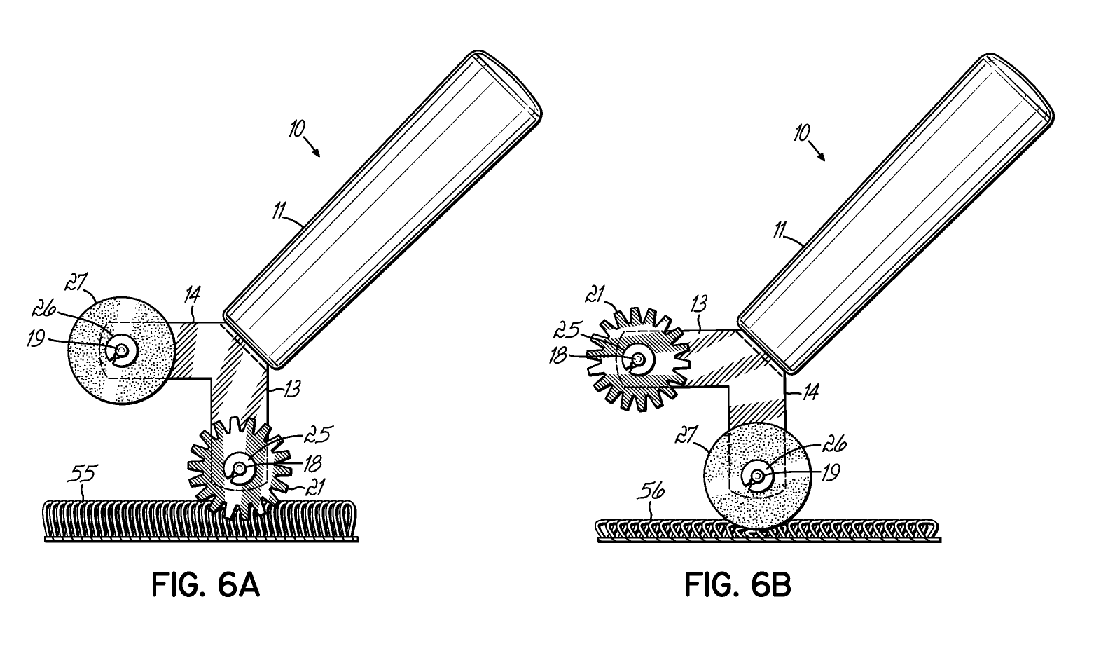

Turning now to FIGS. 6A and 6B, it will be appreciated that the tool is shown in side elevational view as applied to a carpet, such as at carpet 55 (FIG. 6A) and 56 (FIG. 6B). In FIG. 6A, it will be appreciated that the toothed wheels are selected for the particular carpet 55 and the tool is applied to the carpet, such as shown in FIG. 6A with the leg 13 pressing the rollers 21 downwardly through the application of manual force applied through the handle 11, which is disposed at approximately 45 degree angle to the direction of movement of the tool 10 along the carpet 55.

When another carpet 56, which is more suitable for application of the solid roller, such as roller 27, is applied, the tool is simply flipped over. At this point, the leg 13 is lifted away from the carpet and the leg 14 is directed downwardly onto the carpet. Force is applied through the roller 27 exerted by leg 14 onto the carpet 56 via manual pressure applied by handle 11. It will also be appreciated that handle 11, in this position, is also disposed at approximately 45 degrees with respect to the extension of the carpet. Thus, the tool 10 has multiple functions: one for treating carpet edges represented by the carpet 55 and one for another function where the tool is flipped over 180 degrees or rotated 180 degrees about the axis of handle 11, so that the roller 27 can be applied to the carpet 56, as shown in the respective FIGS. 6A and 6B.

Utilization of the tool 40, such as shown in FIG. 3, is similar. Such tool 40 is simply narrower, that is the axle supporting the respective toothed rollers and smooth rollers 53, 54 are simply narrower so that those respective toothed disks 53 and roller 54 are narrower. Such an alternative tool can be utilized in carpet laying conditions where the width of the tool 10 is not necessary.

Turning now to FIG. 5, there is shown therein a further embodiment of the tool 60 where there is only one yoke 61 with one pair of legs 61a and 61b, with the yoke having a bight 62 from which the legs 61a, 61b extend at about 45 degrees from the bight 62 and parallel to each other, but spaced from each other by the length of the bight 62. In this regard, an axle 63 can be carried through the apertures (not shown) in the respective legs 61a, 61b and either toothed wheels 64 or smooth rollers can be used. In this regard, it will be appreciated that the embodiment shown in FIG. 5 as described herein can be used where a less costly tool is desired and where only one form of either toothed wheels 64 or smooth rollers is desired. The yoke 60, of course, is attached to the handle 65 as the respective handles of the prior embodiments were attached to their respective yokes.

Accordingly, the invention provides a multi-function or dual use tool suitable in the application of carpets and in particular the joining of carpet edges at a seam, and together with either toothed wheels or smooth rollers for pressing carpets of different types onto an underlying adhesive, or to be used in connection with intermingling the fibers of adjacent pieces of carpet to obliterate or reduce the visible appearance of a seam between two carpet pieces.

In use, the tool is simply manipulated with a handle at approximately a 45 degree angle to the carpet, providing mechanical advantage to the user for either condition or use of the tool. Similar pressures can be applied to the carpet, regardless of in which position the tool is oriented. Alternative embodiments provide variations in the widths of the toothed wheel assembly or the rollers utilized for engaging and pressing the carpet, and other alternatives provide for single use tools where a less expensive tool for a particular type carpet is desired.

These and other advantages, modifications and alternatives will become readily apparent to those of ordinary skill in the art without departing from the scope of the invention, and applicant intends to be bound only by the claims appended hereto.

Having described the invention, we claim:

1. A carpet tool comprising:
a first shaft;
a second shaft;
a frame supporting each of said shafts;
a handle extending from said frame;
at least one roller on said first shaft; and
a plurality of toothed wheels on said second shaft.

2. A carpet tool as in claim 1 wherein said handle is disposed along an axis, and said shafts are disposed parallel to each other, each perpendicularly extending from a respective line disposed at about 45 degrees to said axis of said handle.

3. A carpet tool as in claim 2 wherein said frame comprises a first set of parallel legs supporting said first shaft.

4. A carpet tool as in claim 3 wherein said frame comprises a second set of parallel legs supporting said second shaft.

5. A carpet tool as in claim 4 including a plurality of toothed wheels on said second shaft between the legs of said second set of legs, and separate pluralities of toothed wheels outside each of said legs of said second set of legs.

6. A carpet tool as in claim 5 including a roller disposed on said first shaft between the legs of said first set of legs and separate rollers outside each of said legs of said first set of legs.

7. A carpet tool as in claim 1 wherein said frame includes a yoke having a bight between separate sets of legs extending from said bight, and a handle extending from said bight along an axis disposed at about 45 degrees with respect to the direction of extension of each of said separate sets of legs.

8. A carpet tool as in claim 7 including a stud extending from said bight into said handle along said axis.

9. A carpet tool as in claim 5 wherein said wheels are stamped.

10. A carpet tool comprising:
a yoke having a bight, a first pair of legs extending parallel to each other at an angle to said bight and a second pair of legs extending parallel to each other at another angle from said bight,
an included angle between said respective pairs of legs being about 90 degrees,
a first shaft mounted on said first pair of legs,
at least one roller on said first shaft,
a second shaft mounted on said second pair of legs,
a plurality of toothed wheels on said second shaft, and
a handle extending on an axis from said bight.

11. A carpet tool as in claim 10 wherein said pairs of legs each extend at an angle of about 45 degrees to said handle axis.

12. A carpet tool as in claim 10 including a plurality of rollers on said first shaft.

13. A carpet tool as in claim 10 including a plurality of rollers on said second shaft between the legs of said second pairs of legs and other pluralities of rollers on said second shaft outside each of said legs of said second pair of legs.

14. A carpet tool comprising:
a frame having at least a pair of legs extending from a bight member,
a handle attached to said bight member and extending at an angle of less than ninety degrees with respect to said legs,
a plurality of one of toothed wheels or rollers mounted on said legs for treating carpet when said tool is manually applied thereto.

15. A carpet tool as in claim 14 including a second pair of legs extending from said bight member and at an angle with respect to said other pair of legs and at an angle with respect to said handle, and a plurality of the other of said toothed wheels or rollers mounted on said second pair of legs.
